(19) United States
(12) Patent Application Publication
(10) Pub. No.: US 2012/0212947 A1
(43) Pub. Date: Aug. 23, 2012

(54) Attachable Safety and Convenience Light

(76) Inventor: Cheryl Wagner, Memphis, TN (US)

(21) Appl. No.: 13/401,410

(22) Filed: Feb. 21, 2012

Related U.S. Application Data
(60) Provisional application No. 61/445,658, filed on Feb. 23, 2011.

(51) Int. Cl. F21L 4/02

(52) U.S. Cl. 362/184

(57) ABSTRACT

A device for providing illumination for convenience and safety is described. The device is constructed of a circular housing with a front and rear face. The front face of the housing is equipped with one or a plurality of LED lights, and may have additional decoration to give the front face the appearance of an angel to appeal to children. Alternatively, the lights may blink for added safety. The rear face of the housing has a chamber for a battery power source, as well as strips of hook and loop fasteners to allow attachment in a variety of locations. Further, the top of the device is equipped with a closable strap or snap hook device to allow fastening to handles, zipper clasps and other structures. The top of the device also has an on/off switch to activate or deactivate the lights.

### CROSS REFERENCE TO RELATED APPLICATION

This application claims the benefit of U.S. Provisional Application No. 61/445,658 filed on Feb. 23, 2011, entitled “Angel Eyes.”

### BACKGROUND OF THE INVENTION

1. Field of the Invention

The present invention relates to a general purpose light. More specifically, the present invention relates to a multi-function light attachable to a variety of clothes or personal effects for safety and visibility.

There are many situations in which it is desirable to have a conveniently accessible light source. In low light conditions, individuals may require an illumination means to locate articles in a dimly lit room or within a personal bag. An easily accessible light source serves as a tool to locate articles in these situations. A light source in a dimly lit area can also improve safety by reducing the risk of injury caused by tripping, falling or being collided into. Of particular concern with regard to the present invention are children walking to a bus stop in the morning before the sun rises. Visibility of the road and of the child themselves on the side of a road are vitally important to the child's safety in these situations.

Another particular situation in which the present invention is concerned involves women searching for their belongings in a purse or handbag. Shadows in the purse, even in bright light and especially in darkened areas, can cause items to be misplaced or difficult to find within the bag, particularly small items such as keys and coins. Accordingly, many women carry a flashlight in their purse. However, such lights must be small to accommodate the small size of a purse. Finding a flashlight itself can be a difficult in low light situations, exacerbating the aforementioned conditions. Still further, if the light is difficult to activate or handle, the advantages associated therewith are further inhibited.

For children, being visible in low light conditions is more of a concern than finding belongings. When children are walking on busy roads in low light conditions, it is highly desirable to improve their visibility with a light source. Many parents would be amenable to affixing a small constant or blinking light to clothing or paraphernalia carried by their child, such a device would increase visibility.

The present invention provides such a light source to address these concerns. The light source provides a circular housing comprising several Light Emitting Diode (LED) lights. The housing includes an ornamental design of a smiley face or similar aesthetic quality, while a dislocating strap is provided for attachment to the outside of a schoolbag, the inside of a purse, diaper bag, brief case, or in a location within a dimly lit room wherein the light source may easily be retrieved and utilized. There exists a void in the prior art for a convenient, attachable light source that is usable for locating items and increasing safety in a variety of conditions. The present invention fulfills these needs by providing a light source attachable in a variety of manners in a design appealing to both children and adults.

2. Description of the Prior Art

Several patent applications have published and patents have been granted for devices related to portable illumination products. While these prior devices may be suitable for the issues for which they are intended, they fail to present a versatile device capable of providing illumination in a variety of conditions. The present invention is useful for situations where illumination is needed to locate an object, as well as in situations in which illumination may be used to locate an object or individual for improved awareness and safety. These prior inventions fail to address both of these issues, in favor of addressing only one, along with failing to disclose the structure and spirit of the present invention.

Several previous published applications and granted patents describe devices used to illuminate purses. Tait U.S. Patent Publication No. 2010/0097012 is directed to a purse illumination assembly including a power source, a light emitting portion, a touch-sensitive switch, and a circuit assembly connecting the light emitting portion to the power source through the touch-sensitive switch. The light emitting portion includes a light emitting fabric or may include EL wire in combination with LED lights to provide both lighting and a decorative effect. Further, Tait U.S. Pat. No. 7,207,689 is directed to touch-activated purse illumination assembly having a base unit housing a circuit assembly, a power source and at least one elongated light emitting portion. Touch sensitive switching is included in the circuit assembly, and features a pair of partially exposed electrical contacts on the exterior of the base housing unit. After being activated by the touch sensitive switching means, the light emitting portion is energized by the power source for a preset amount of time. Similarly, Teal U.S. Pat. No. 5,005,111 is directed to a light assembly used in a purse and releaseably attached to one inside surface of such purse by a hook and loop fastener. The light includes a switch that automatically turns on the light as soon as the purse is opened, and includes an alarm system that generates an audible signal after a pre-set time interval after the purse is opened unless the alarm is de-activated.

Additionally, Biggs U.S. Pat. No. 5,018,057 is directed to a light module adapted to provide light temporarily in a confined space and comprises a generally oblong and relatively thin housing that retains a bulb for providing a source of light, a power source sufficient to activate the bulb, and an electrical control circuit. The circuit includes a touch sensitive sensor for closing a circuit between the bulb and the power source to turn on the bulb, and a timer for opening the circuit to turn off the bulb after it has been on for a set period. The circuit also contains elements for requiring the sensor to be touched twice within a limited period in order to activate the bulb. U.S. Pat. No. 6,582,093 to Branaugh is directed to another purse illuminating device. The purse has a main storage area. A flap member has a first end permanently coupled to the main storage area and a second end removeably coupled to the main storage area. A lighting device is coupled to the purse. The lighting device has a power supply and a light element coupled to the power supply. A housing unit is affixed to the flap member of the purse and holds the power supply and light element. A spring loaded switch couples to the flap member and automatically causes the lighting device to activate when the flap member is lifted.

The Tait publication and the Tait, Teal, Biggs and Branaugh patents are directed to devices intended to be affixed inside of purses. These devices do not have the same versatility as the present invention, which is fully capable of attachment to nearly any bag or clothing item. These inventions, while addressing the need for a light within a purse, fail to provide illumination in other situations, such as those where safety is a concern.

Other issued patents describe inventions that are essentially miniaturized flashlights. Vandenbelt U.S. Pat. No. 5,463,539 is directed to a miniature pocket flashlight including a battery receptacle and electrical switch unit, a lamp, and a lens module with an integral lens element that are all encased and covered by an outer sheath of flexible material. The lens module is mounted to an end of the battery receptacle and electrical switch unit, has a central passage formed therein behind the lens element that receives, surrounds, and protects the lamp that is also mounted and electrically connected to the one end of the unit. A pair of flaps connected together at one end to define an aperture for external exposure of the lens element forms the flexible outer sheath of the pocket flashlight. The outer sheath is stretched over the components and the peripheral edges of the flexible flaps are attached to one another to encase and enclose together the lens module, lamp and battery receptacle and electrical switch unit. The Vandenbelt device has all of the inherent disadvantages of a flashlight. Namely, such a device can be difficult to find in a purse or bag and it fails to be affixed in an easily locatable area. The present invention addresses both of these issues.

Still other issued patents describe inventions useful for illuminating drawers or permanent containers such as chests. Liu U.S. Pat. No. 6,203,167 is directed to an electrical light fixture for brightening the usually dimmer portion of a drawer storage area. This electrical light fixture is small enough to attach to an inside surface of a desk. When attached, it is preferably located immediately above the storage area of a desk drawer. This invention does reduce available drawer space for storage. In addition, this electrical light fixture uses battery power for providing automatic lighting turn-on when the drawer opens and for providing automatic turn-off when the drawer closes. Alternatively, the automatic turn-off occurs after a pre-determined amount of time. This light fixture is especially convenient for those individuals who have vision difficulties either because of an illness, a surgical operation or from age. The present invention is designed to be useful in a variety of situations rather simply installed in a drawer location. Its structure is sufficiently diverging from the present invention as well, wherein the present invention provides an attachable article with imbedded LEDs and a character on its illuminating surface.

Other patents have described inventions for other clothing articles such as hats. Schlapkohl U.S. Pat. No. 6,634,031 is directed to an illumination system for a hat. The system includes a light pivotally connected to an attachment mechanism constructed of hook and latch material. The hook and latch material is provided around an adjustment band of a typical “baseball cap.” Batteries and a touch sensitive switch are coupled to the light with the touch sensitive switch facing inward. The cap is usable in its standard orientation during the day to shield the sun's rays from the user's eyes. At night, or indoors, the cap may be reversed. In the standard orientation the touch sensitive switch is blocked from contact with the skin by the user's hair, in the reversed orientation the touch sensitive switch contacts the user's forehead, actuating the light for use. The present invention differs in structure and intent from the Schlapkohl patent, and further is not limited to being affixed to one type or specific article of clothing.

The present invention is an illumination means that serves several functions, most notably providing convenient access to an illuminating object in a dimly lit area for locating articles, while also providing a situational awareness and safety device that provides notice to others of a wearer's presence. Rather than resorting to passive reflectors, the present invention may be affixed to an individual for projecting outwardly-facing illumination that allows improved location of the individual in low light situations. There is currently a need in the art for a device that is versatile and useful in a variety of situations that provides illumination and alleviates safety hazards in low light conditions. The present invention is substantially divergent in design elements from the prior art, consequently it is clear that there is a need in the art for an improvement to the existing attachable illumination devices. In this regard the instant invention substantially fulfills these needs.

### SUMMARY OF THE INVENTION

In view of the foregoing disadvantages inherent in the known types of attachable illumination means now present in the prior art, the present invention provides a new attachable illumination means wherein the same can be utilized for providing convenience for the user when locating an object in the dark in a purse or bag or providing increased visibility of an individual in low light situations.

The present invention is a small, portable light that may be used for convenience and safety purposes. The light comprises a structure with a surface likeness of a smiling face with a halo thereabove, and may be attached in a variety of locations to provide light wherever and whenever necessary. A separable strap allows the device to be attached to any structure for which the strap may be wrapped around or through. It is ideal for mounting inside of a purse, book bag, briefcase, toolbox, drawer, or even attached to the outside of a bag or purse. The device enables individuals to locate items in dimly lit conditions, such as at the bottom of a bag or when in a darkened room. The device also provides a safety device that ensures individuals are easily seen and located in low light conditions. This device is usable in a wide variety of situations ranging from convenience to safety.

It is therefore an object of the present invention to provide an attachable light source for convenience of the user when locating items in bags or other enclosed areas that may not be sufficiently lit.

Another object of the present invention is to provide an attachable light source for use in increasing the visibility of both children and adults in low light conditions for safety and tracking purposes.

Another object of the present invention is to provide an illuminating structure that employs a smiley face design or similar ornamental feature on the illuminating surface that is pleasing to a directed audience.

Another object of the present invention is to provide an LED light source that projects high intensity illumination, and one that is easily attachable to a larger structure, is easily operable and runs on battery power.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself, and manner in which it may be made and used, may be better understood by referring to the following description taken in connection with the accompanying drawings.

FIG. 1 shows a perspective view of the present invention, highlighting the illuminating surface wherein an ornamental design is provided thereon.

FIG. 2 shows a perspective view of the present invention, highlighting the rear face, wherein battery access is provided and additional attachment means are provided.

FIG. 3 shows a perspective view of the present invention in use within a purse.

FIG. 4 shows a perspective view of the present invention in use in conjunction with a backpack.

### DETAILED DESCRIPTION OF THE INVENTION

Reference is made herein to the attached drawings. Like reference numerals are used throughout the drawings to depict like or similar elements of the attachable illumination means. For the purposes of presenting a brief and clear description of the present invention, the preferred embodiment will be discussed as used for providing a user with an easily accessible and attachable light source and combined safety device for low light situations. These figures are presented for representative purposes only and should not be considered to be limiting in any respect.

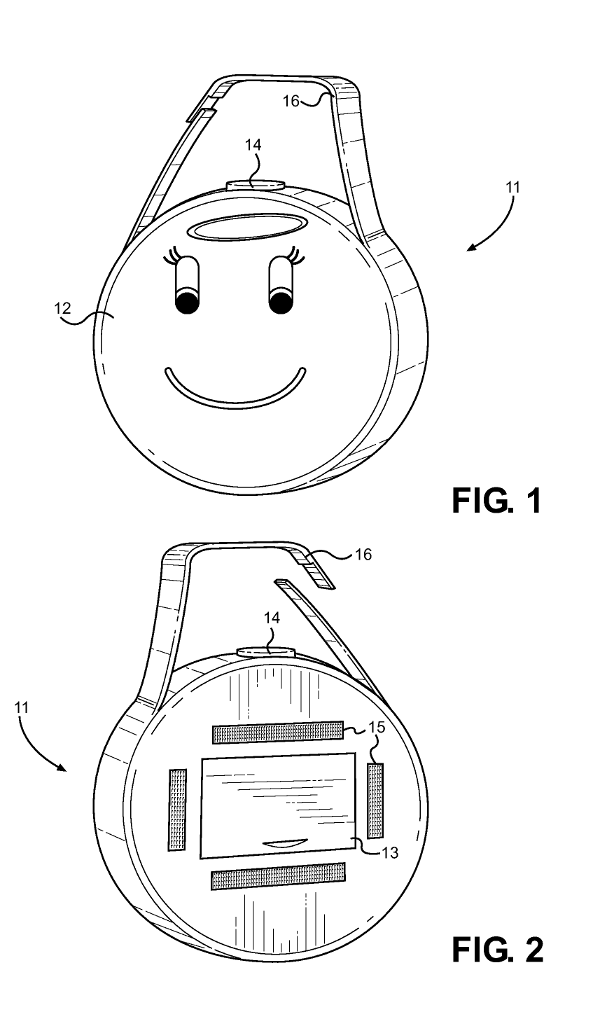

Referring now to FIG. 1, there is shown a perspective view of an illuminating structure with an embodiment of an attachment means as described by the present invention, highlighting the front face. The device comprises a circular housing 11 having a front and rear face as well as a surface around its circumference. The front face 12 provides projection of light emanating from within the housing 11 via a plurality of imbedded LED, and may be adorned with an ornamental design or feature making the front face resemble a smiley face, an angel or any other suitable design that is desired by a user. An on/off switch 14 is provided along the circumferential surface to activate and deactivate the LED lights. An attaching strap 16 is affixed to the upper portion of the circumference of the housing to allow attachment to a variety of structures to suit a given situation. Also contemplated is the use of a snap hook device or key clip attachment, which is particularly suited for attaching to zipper clasps and other attachment areas on a bag.

Referring now to FIG. 2, there is shown a perspective view an illuminating structure with an embodiment of the attachment means as described by the present invention, wherein the rear face of the structure is highlighted. The rear face of the housing 11 is equipped with a battery compartment 13, into which batteries may be installed to power the imbedded circuitry and LED lights. A strap 16 is attached to the upper portion of the housing to allow attachment of the device to a third party object or structure. The strap 16 may be replaced or utilized in conjunction with a snap hook device or similar key ring clasp. An ancillary attachment means 15 is also provided along the rear surface of the housing 11. These attachment means preferably include a plurality of hook and loop fastener 15 strips that allow attachment to complementary hook and loop strips mounted to a flat surface for securement of the housing thereto.

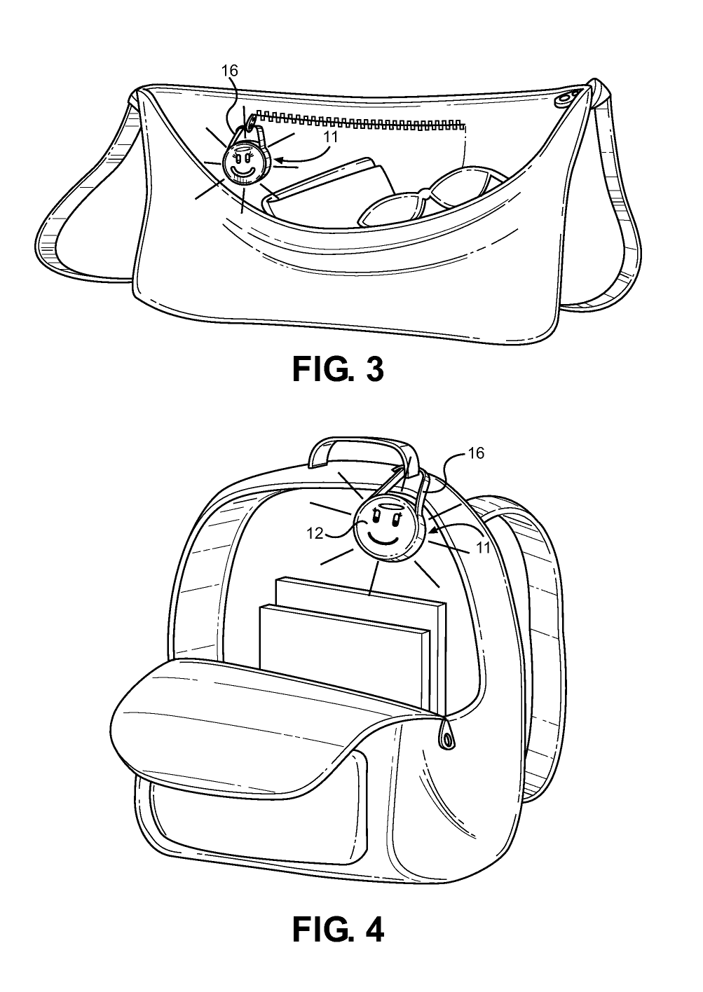

Referring now to FIG. 3, there is shown a perspective view of the present invention in use within a purse. The device is attached a mounting structure within the interior of the purse, such as a zipper or loop therein, using the detachable strap 16 along the upper portion of the housing 11. The strap 16 is detachable in the sense that it can be separated into two lengths that can wrap around another structure and reattach to form a cohesive strap that secures the housing to the structure. The LED lights projecting through the front face of the device are activated using the on/off switch 14 and controlled by the user, allowing illumination within the cavity of the purse for locating objects therein. The device may be located within the purse or just outside the cavity of the purse such that the light illuminates the entire cavity or the user can direct the light as needed to locate an object in the dark with little difficulty.

Referring now to FIG. 4, there is shown a perspective view of the present invention connected to a backpack. In this location, the present invention increases visibility of a child walking in the dark, as well as providing illumination to locate objects within the backpack. The strap 16 of the housing 11 can be affixed to any handle or exterior strap attached to of a backpack and be turned on to provide a device that highlights a wearer's position while carrying the backpack.

The present invention provides a small light that can be used in a variety of applications. The device is comprised of a circular housing 11 that includes one or a plurality of LED lights projecting through its front face 12. The front of the housing may be in the likeness of a smiling face with a halo or any ornamental or aesthetic design that suits the end user. The projection of the LED lights through the front face provides a source of illumination while highlighting the ornamental design thereon. The rear face of the housing includes battery chamber 13 for installing battery power. A depressible on/off button 14 is located on the circular housing perimeter to control activation of the lights 12. In an embodiment of the LED lights 12, the illumination may be equipped to optionally blinking to increase visibility when utilized in a safety situation. The design may include one or more hook and loop fasteners 15 on the back so that it may adhere to variety surfaces, such as the inside of a purse, toolbox, briefcase, straps stand the like. The hook and loop fasteners 15 may be in both horizontal and vertical orientations allowing the device to be affixed to a strap or surface in any orientation. The device strap 16 allows the device to be affixed to straps, belt loops or similar structures. In an embodiment of the strap means 16, the strap may be replaced by a spring-loaded clasp mechanism that functions similar to a carabineer, allowing the device to be clipped onto another structure.

In use, an individual attaches the device to an article of clothing or a purse or bag using either the attachment means 16 or the rear hook and loop fasteners 15. When light is required, such as to look into a purse, diaper bag or brief case, the lights 12 are activated by pressing the on/off button 14 on the upper portion of the housing 11. The device can also be attached to a child's clothing or bag to assist a parent tracking or locating the child at night. In such safety situations, the device could be set to a blinking mode, to increase visibility of the child along a roadway. The present invention is also particularly useful in dimly lit mornings or evenings wherein a child must walk along a roadway or long driveway to be picked up or dropped off from a school bus.

Internal to the housing of the device are electrical connections between the battery power supply and electronics that control the illumination of the LEDs. Internal circuit logic controls the LED operation, as well as the timing of the blinking mode, wherein the LEDs are activated and then turned off according to a continuous pattern until deactivated by the user. This provides light bursts that attract attention, improving an individual's ability to be located or visualized in a given low light situation.

To this point, the instant invention has been shown and described in what is considered to be the most practical and preferred embodiments. It is recognized, however, that departures may be made there from within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An illumination device comprising:
a circular housing having a front face, rear face and a surface around the circumference connecting said front and rear faces;
one or a plurality of LED lighting means within said housing;
said front face adapted to project or allow transparency for said LED lighting means;
a battery chamber located on said rear face of said circular housing;
an on/off switch to activate or deactivate said LED lighting means;
an attachment means along an upper portion of said housing.

2) A device as in claim 1, wherein said front face further comprises an ornamental design.

3) A device, as in claim 2, wherein said ornamental design resembles a smiley face with a halo.

4) A device as in claim 1, wherein said attachment means comprises a separable strap for wrapping around an external structure.

5) A device as in claim 1, wherein said attachment means comprises a spring-loaded clasp mechanism.

6) A device as in claim 1, wherein said attachment means comprises a snap hook mechanism.

7) A device as in claim 1, further comprising strips of hook and loop fasteners on said rear face of said housing.

8) A device as in claim 1, comprising an LED blinking function wherein said LEDs are illuminated for short bursts to improve visibility.
